(19) United States
(12) Patent Application Publication
(10) Pub. No.: US 2005/0262500 A1
(43) Pub. Date: Nov. 24, 2005

(54) System and method for updating information handling system applications at manufacture

(76) Inventor: Michael Stanley, Round Rock, TX (US)

Correspondence Address: HAMILTON & TERRILE, LLP, P.O. BOX 203518, AUSTIN, TX, 78720, US

(21) Appl. No.: 10/848,876

(22) Filed: May 19, 2004

(51) Int. Cl. G06F 9/44

(52) U.S. Cl. 717/173

(57) ABSTRACT

Information handling systems are manufactured with images having selected applications, such as operating system, word processing, antivirus and firmware applications, and one or more updates associated with one or more of the applications. The updates are configured to automatically prompt the user to install the updates on initial start-up of a manufactured and shipped information handling system. Registry settings configured at manufacture of the information handling system automatically calls the update install user interface as though the user had run the download user interface to download the update from the application's manufacturer. Preloading updates improves information handling system security by avoiding update downloads by unprotected information handling systems, and use of the application manufacturer's interface to install updates through the end-user purchaser decreases disruption of information handling system manufacture.

### BACKGROUND OF THE INVENTION

1. Field of the Invention

The present invention relates in general to the field of information handling system application updates, and more particularly to a system and method for updating information handling system applications at manufacture of the information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally process information by running software applications. The application that coordinates operations of other hardware and software components is the operating system, such as WINDOWS from MICROSOFT. Other applications generally run on top of the operating system to perform specific functions, such word processing, virus protection and network communication, like e-mail. The information handling system applications that have experienced the greatest growth over the past several years have been networking applications, such as e-mail applications and browsers for downloading information from the Internet. Depending upon an information handling system's hardware and Internet access configurations, a user may download information at very rapid rates, such as with a broadband DSL or cable Internet access, or at substantially slower rates, such as with dial-up modem access. With the advent of widespread Internet use, a growing problem faced by information handling system users is the avoiding and management of malicious programs, such as worms and viruses. Malicious programs are typically designed to gain access to an information handling system in a stealthy manner, such as through operating system vulnerabilities, and, once a malicious program executes on an information handling system, the malicious program generally performs destructive functions, such as spreading to other systems using the e-mail address book on the system, destroying data stored on the system, or distributing confidential information from the system through the Internet.

In order to protect an information handling system, users generally must periodically download application updates that guard against malicious programs as the programs are discovered. For instance, MICROSOFT maintains an Internet update site for users to download updates that correct newly-discovered vulnerabilities in the WINDOWS operating system as well as various applications, such as the OUTLOOK e-mail application and the WORD word processing application. The MICROSOFT updates are known as Quick Fix Engineerings or QFEs. Virus applications are also periodically updated through the Internet to protect against newly discovered malicious programs, such as the NORTON LIVE UPDATE application. Although Internet updates have helped considerably in the control of malicious programs, users must generally take some initiative to access the update site, download the updates and load the updates on an information handling system. Some updates are of considerable size so that user's having slower Internet access, such as a dial-up connection, face considerable download times, and an information handling system often remains vulnerable to malicious programs during the download. Lengthy download times are exasperated where an information handling system is not up-to-date with current updates, such as after initial manufacture. The installation of updates at manufacture is often prohibitively time consuming since updates often are executed separately, require re-booting of the information handling system and require monitoring to manage update installation failures.

### SUMMARY OF THE INVENTION

Therefore a need has arisen for a system and method which manages application updates for manufacture of information handling systems.

In accordance with the present invention, a system and method are provided which substantially reduce the disadvantages and problems associated with previous methods and systems for managing information handling system application updates. An application's update is included in an image copied to a manufactured information handling system with the update's install user interface prepared to run. The information handling system is configured so that the install user interface automatically displays on start-up of the information handling system by an end-user purchaser in order to leverage the application manufacturer's update install process.

More specifically, an image engine associated with an information handling system manufacturing system includes selected applications in images copied to manufactured information handling systems. An update engine associated with the image engine includes updates in the image for the selected applications that have associated updates. The update engine includes the updates in the state that results from download of the update by an information handling system from an application manufacturer update system, such as the MICROSOFT QFE update system. A configuration engine interfaces with the manufactured information handling system to change registry settings during test and configuration of the information handling system. The registry settings allow the information handling system to identify the update as downloaded upon initial end-user purchaser start-up and to automatically display for the end-user purchaser the install user interface of the update. In this manner, the information handling system is protected with updates before the user faces a vulnerable situation, such as network communication, and the update occurs with leverage of the application manufacturer's update installation process so that minimal disruption is introduced at image manufacture, allowing an information handling system manufacturer to rapidly include updates as part of the manufacture process.

The present invention provides a number of important technical advantages. One example of an important technical advantage is that application updates are included in manufactured information handling systems with minimal impact on the manufacture process. Information handling system users face minimal disruption of initial system use since the updates are ready for execution using the application's own update interface. Information handling system vulnerability to malicious programs is reduced since the initial user need not perform a network download of updates before updates are loaded on the information handling system. In addition, users having slower Internet access rates will not face delays in system use that generally accompany substantial downloads. The convenient execution of updates loaded on a manufactured system also improves user education regarding the desirability of performing updates to enhance overall Internet security.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a system for manufacture of information handling systems having application updates; and

FIG. 2 depicts a process for manufacture of information handling systems with application updates configured to automatically install by an end-user purchaser.

### DETAILED DESCRIPTION

Information handling systems manufactured with selected applications are configured to automatically execute one or more updates for one or more applications through an end-user purchaser by preloading application manufacturer updates on the information handling systems. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

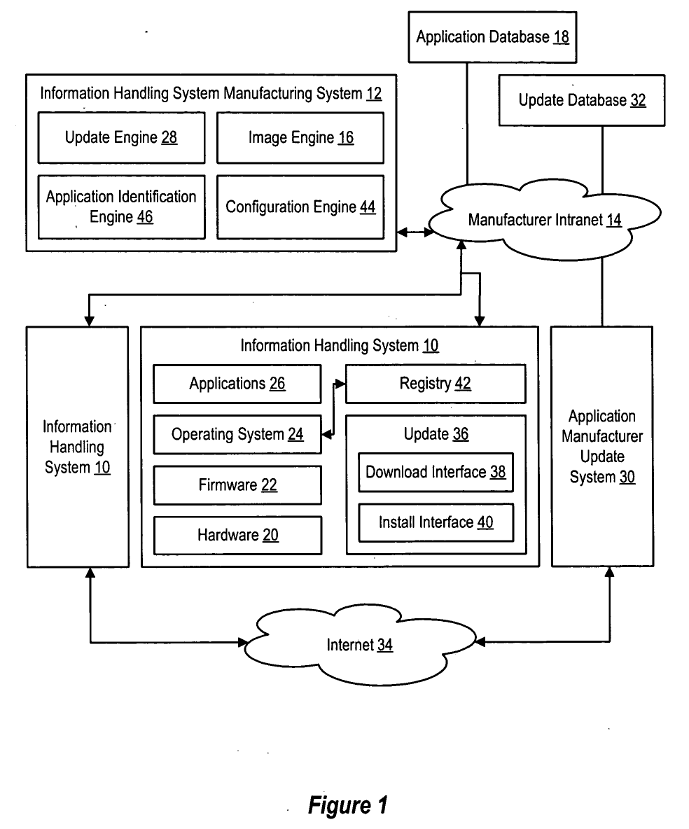

Referring now to FIG. 1, a block diagram depicts a system for manufacture of information handling systems having application updates. Information handling systems 10 are manufactured with selected components for an end-user purchaser, such as in a build-to-order manufacture process. Once hardware components of each information handling system 10 are assembled in an operable relationship, each information handling system 10 interfaces with an information handling system manufacturing system 12 through a manufacturer's intranet 14. An image engine 16 determines applications selected for each interfaced information handling system 10, such as by reference to unique identifications readable from firmware of an information handling system 10, and prepares an image having the selected applications for download from an application database 18. Generally, the applications include an operating system, such as WINDOWS or Linux, a variety of utilities, such as an anti-virus application, and user requested applications, such as WORD for word processing or other OFFICE components. For instance, information handling systems 10 are often viewed as having a physical hardware layer 20 that operates under a firmware layer 24, such a BIOS that coordinates communication between physical devices, that operates under an operating system layer 24. An application layer 26 operates over the operating system layer 24 to perform functions desired by the user, such as word processing, network communication and antivirus protection.

In order to create images on manufactured information handling systems that have applications with updates that are as current as possible, an update engine 28 includes in the image generated by image engine 16 application updates associated with applications selected for the information handling system. Update engine 28 periodically queries the application manufacturer update system 30 to detect the most current updates and downloads the updates to an update database 32 for use in creating images for manufactured information handling systems. Updates 36 are designed by application manufacturers for download through internet 34 to end user information handling systems by presenting the end user with a download interface 38 that manages download of the update and an install user interface 40 that manages installation of the update to the information handling systems. For instance, QFEs change registry 42 settings upon completion of a download so that the operating system recognizes the downloaded updates and automatically displays install user interface 40 to prompt the user to install the update. QFEs perform updates in this manner for the WINDOWS operating system, the OFFICE suite of applications, and firmware of various hardware components, such as video cards. Update engine 16 leverages the functions of manufacturer updates, such as QFEs, by copying an update 36 to a manufactured information handling system as part of the manufacture image, and using a configuration engine 44 to change the registry settings so that install user interface 40 displays on start-up by the purchaser end-user to prompt installation of the update. An application identification engine 46 tracks the association of updates with applications to ensure that images have the correct updates included for the selected applications.

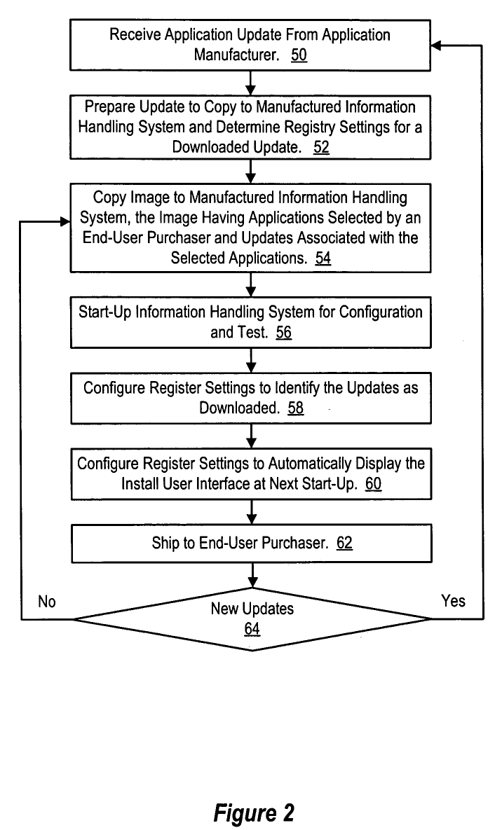

Referring now to FIG. 2, a flow diagram depicts a process for manufacture of information handling systems with application updates configured to automatically install by an end-user purchaser. The process begins at step 50 by receiving at an information handling system manufacturer an application update from an application manufacturer. Updates may be sent to the information handling system manufacturer on a periodic basis, such as monthly, or downloaded by the information handling system manufacturer through periodic queries to the application manufacturer's update site. Since the inclusion of the update in the manufacture image leverages the installation process of the application update itself, minimal disruption is introduced to the preparation of images with the most recent updates. At step 52, the update is prepared to copy to manufactured information handling systems as it would be downloaded to a deployed information handling system interacting with the application manufacturer's update site, and registry settings are determined that will allow a manufactured information handling system to recognize and install the update on initial start-up by an end-user purchaser.

After the application update is prepared for inclusion in a manufacture image, the update is inserted in images having the associated application for as long as the update remains valid. At step 54, an image is copied to a manufactured information handling system with the application included as an application selected by an end-user purchaser. The image includes one or more updates associated with one or more of the selected applications, including for instance operating system updates, antivirus updates, word processing updates and firmware updates. At step 56, the information handling system is started-up for test and configuration in support of the manufacture process. At step 58, before power-down and shipment of the information handling system, the configuration includes register settings to allow the information handling system to identify the updates as downloaded. Similarly, at step 60 the configuration includes register settings to automatically display the install user interface at the next start-up. For instance, with a QFE the AutoUpdate registry key is enabled. At step 62, the manufactured information handling system is shipped to the end-user purchaser. Upon start-up, the information handling system presents desired registration and introduction information and then, on the first display of the operating system for operational use, presents the update install user interface so that the user is able to install updates before using the information handling system in a vulnerable manner, such as Internet communication. At step 64, a determination is made of whether additional updates exist, in which case the process returns to step 50 to include the additional updates. If the updates are current, the process continues to step 54 for the continued manufacture of information handling systems.

Although the present invention has been described in detail, it should be understood that various changes, substitutions and alterations can be made hereto without departing from the spirit and scope of the invention as defined by the appended claims.

1. A method for manufacture of an information handling system, the method comprising:
copying an image to the information handling system, the image having one or more applications;
copying one or more updates to the information handling system, the updates operable to run on the information handling system to update one or more of the applications, the updates having a download user interface and an install user interface;
configuring the information handling system to identify the updates as downloaded on the information handling system; and
configuring the information handling system to display the install user interface after the initial user start-up of the information handling system.

2. The method of claim 2 further comprising:
shipping the information handling system to a user;
completing a user registration interface at information handling system start-up; and
displaying the install user interface at the information handling system.

3. The method of claim 1 wherein configuring the information handling system to identify updates as downloaded further comprises setting registry changes associated with a successful download through the download interface.

4. The method of claim 1 wherein configuring the information handling system to display the install user interface after the initial user start-up further comprises setting registry changes associated with display of the install user interface.

5. The method of claim 1 wherein the application comprises the operating system of the information handling system.

6. The method of claim 1 wherein the application comprises a word processing application.

7. The method of claim 1 wherein the application comprises an anti-virus application.

8. A system for manufacture of information handling systems having plural applications, one or more of the applications having one or more associated application updates, the updates having a download user interface and an install user interface, the system comprising:
an image engine operable to copy a desired image to an information handling system, the image having selected of the plural applications;
an update engine operable to copy to the information handling system one or more updates associated with one or more of the plural applications; and
a configuration engine operable to configure the information handling system to identify the updates as downloaded and to display the install user interface upon initial user start-up of the information handling system.

9. The system of claim 8 wherein the install user interface is operable to display a prompt for the user to initiate installation of the updates.

10. The system of claim 8 wherein the configuration engine configures the information handling system by to setting registry changes on the information handling system, the registry changes associated with successful download of updates.

11. The system of claim 8 wherein the configuration engine configures the information handling system by to setting registry changes on the information handling system, the registry changes associated with display of the install user interface.

12. The system of claim 8 wherein the update comprises an operating system update.

13. The system of claim 8 wherein the update comprises a word processing application update.

14. The system of claim 8 wherein the update comprises an antivirus application update.

15. The system of claim 8 wherein the updated comprises a firmware update.

16. The system of claim 8 wherein the information handling system comprises a build-to-order manufactured system, the system further comprising an application identification engine interfaced with the image engine and operable to identify the selected applications that have associated updates.

17. A method for manufacture of an information handling system for a user, the method comprising:
receiving periodic updates for an application from the application manufacturer, each update having a download interface to manage a user download of the update to an information handling system and an install interface to manage a user installation on the information handling system;
copying an image to a manufactured information handling system, the image having the application and the update;
configuring the information handling system to register the application update;
configuring the information handling system to automatically display the update install user interface on start-up by a user; and
shipping the information handling system to the user.

18. The method of claim 17 wherein the application comprises an operating system.

19. The method of claim 17 wherein the application comprises a word processing application.

20. The method of claim 17 wherein the application comprises an anti-virus application.
